(19) United States
(12) Patent Application Publication
(10) Pub. No.: US 2005/0029435 A1
(43) Pub. Date: Feb. 10, 2005

(54) Photo-interrupter and method of manufacturing the same, and optical coupling apparatus and method of manufacturing the same

(76) Inventor: Isao Ogawa, Kitakyushu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/882,257

(22) Filed: Jul. 2, 2004

(30) Foreign Application Priority Data
Jul. 4, 2003 (JP) 2003-191921

(51) Int. Cl. H01J 40/14; G01N 5/00; G01V 8/00

(52) U.S. Cl. 250/214 R; 250/559.4

(57) ABSTRACT

A photo-interrupter is disclosed, which comprises a molded light emitting element unit including a first lead frame and a light emitting element mounted on and connected to the first lead frame, the first lead frame having a reflector portion, a molded light receiving element unit including a second lead frame and a light receiving element mounted on and connected to the second lead frame, the second lead frame having a different shape from the first lead frame, and an envelope molding formed in one piece with the light emitting element unit and the light receiving element unit, in which the light emitting element unit and the light receiving element unit are arranged with a predetermined gap therebetween, the envelope molding having a light guiding hole for guiding a light beam emitted from the light emitting element unit to the light receiving element.

### CROSS-REFERENCE TO RELATED APPLICATIONS

This application is based upon and claims the benefit of priority from prior Japanese Patent Application No. 2003-191921, filed Jul. 4, 2003, the entire contents of which are incorporated herein by reference.

### BACKGROUND OF THE INVENTION

1. Field of the Invention

The present invention relates to a photo-interrupter and a method of manufacturing the same, and an optical coupling apparatus and a method of manufacturing the same.

2. Description of the Related Art

Generally, photo-interrupters are broadly used for detection of remaining papers in a printer, or the like, as a sensor detecting a position of an object in non-contact by detecting variation in an optical signal when an object passes through between a light emitting element and a light receiving element.

A conventional photo-interrupter is shown in FIG. 17.

As shown in FIG. 17, in the photo-interrupter, a light emitting element unit 101 and a light receiving element unit 102 are inserted in a casing 104 made of a thermoplastic resin. The casing 104 has a light emitting side portion and a light receiving side portion which face one another with a predetermined gap 103 therebetween, and the light emitting element unit 101 and the light receiving element unit 102 are disposed at the light emitting side portion and the light receiving side portion, respectively.

As shown in FIG. 17 and FIG. 19, The light emitting element unit 101 includes a light emitting side lead frame 101a, a light emitting element (not shown) placed on and connected to the lead frame 101a, and a resin portion 101c molding the lead frame 101a and the light emitting element. The light receiving element unit 102 has a light receiving side lead frame 102a, a light receiving element (not shown) placed on and connected to the lead frame 102a, and a resin portion 102c molding the lead frame 102a and the light receiving element.

A lens 101e whose radius of curvature is 0.75 mm and a lens protecting portion 101f are provided in a form of being projected from the resin portion 101c of the light emitting element unit 101. In the same way, a lens 102e whose radius of curvature is 0.75 mm and a lens protecting portion 102f are provided in a form of being projected from the resin portion 102c of the light receiving element unit 102.

Such a photo-interrupter is formed in accordance with a process flow as shown in FIG. 18. At light emitting element unit forming process 111, light emitting elements are respectively placed on and connected to a plurality of lead frames of a unit frame, not shown, of a predetermined pattern (i.e., a die bar having a predetermined length in which a plurality of lead frames are coupled to one another). The light emitting elements and lead frames are molded with resin to form the light emitting units. When the light emitting elements and lead frames are molded, a lens 101e whose radius of curvature is 0.75 mm and a lens protecting portion 101f are also provided on the molding of each of the light emitting element units 101. In this way, the light emitting element unit is provided.

A light receiving element forming unit process is carried out in substantially the same way as the light emitting element unit forming process. That is, at the light receiving element forming process 112, light receiving elements are respectively placed on and connected to a plurality of lead frames of a unit frame, not shown, of the same pattern as the that of the unit frame used in the light emitting element forming process 111. The light receiving elements and lead frames are molded with resin to form the light receiving units. When the light receiving elements and lead frames are molded, a lens 102e whose radius of curvature is 0.75 mm and a lens protecting portion 102f are also provided on each of the light receiving element units 102. In this way, the light receiving element unit is provided.

Next, at coupling process 113, the above-described molded light emitting element unit 101 and light receiving element unit 102 are pressed into the casing 104 formed by injection-molding with thermoplastic resin, such that the light emitting plane and the light receiving plane (i.e., the lens 101e side and lens 102e side) face one another, and are fixed at portion 109 by thermocompression or adhesion.

With respect to such a photo-interrupter, in order for the photo-interrupter to be mounted on a miniature device, such as a digital still camera, for which demand has been increasing in recent years, and in order to make a device such as a printer smaller and lighter, miniaturization of the photo-interrupter has come to be strongly requested. However, a conventional photo-interrupter requires a lens in order to ensure a detection sensitivity, and since the lens occupies ⅓ to ¼ of the thickness of the photo-interrupter body, there has been a limit to the miniaturization thereof.

Further, there has been the problem that since a lens is provided, a volume of resin is large, and thus the gap of resin is made large, which affects the reliability of the photo-interrupter. On the other hand, in the manufacturing process, for example, there has been the problem that the cost of a mold becomes high since the lens portion is formed, and molding thereof takes time because a mirror finish for the lens is needed.

Moreover, after the light emitting elements and the light receiving elements are placed on the respective frames and connected thereto, the light emitting element unit and the light receiving element unit are molded, and the lens portion as well is fixed by the mold at the time of the molding. Bubbles are generated at the time of this molding, and in order to suppress the residual bubbles in the lens portion, the lens portion must be disposed at a portion below the mold. However, in order to dispose the lens portion at a portion below the mold, because the frame must be reversed upside down, it has been difficult to maintain production on a hoop line. Therefore, the productivity falls.

Further, at the time of coupling process for the light emitting element unit and the light receiving element unit, because it is not easy to insert the light emitting element unit and the light receiving element unit into the casing while maintaining optical connection of the lens of the light emitting element unit and the light receiving element unit, it has been necessary to prepare a casing which highly costs.

Moreover, before the insertion of the light emitting element units and light receiving element units into the casing, the molded light emitting element units and light receiving element units are separated into individual bodies, and the separated light emitting and receiving element units are aligned again by using a parts feeder. Thereafter, the separated units are inserted into the casing, and fixed by thermocompression or the like. Thus, the time and the number of processes increase, and the production cost has increased.

### BRIEF SUMMARY OF THE INVENTION

According to an aspect of the present invention, there is provided a photo-interrupter comprising:
a molded light emitting element unit including a first lead frame and a light emitting element mounted on and connected to the first lead frame, the first lead frame having a reflector portion;
a molded light receiving element unit including a second lead frame and a light receiving element mounted on and connected to the second lead frame, the second lead frame having a different shape from the first lead frame; and
an envelope molding formed in one piece with the light emitting element unit and the light receiving element unit, in which the light emitting element unit and the light receiving element unit are arranged with a predetermined gap therebetween, the envelope molding having a light guiding hole for guiding a light beam emitted from the light emitting element unit to the light receiving element.

According to another aspect of the present invention, there is provided a method of manufacturing a photo-interrupter, comprising:
forming a hoop shaped frame in which light emitting element side frames and light receiving element side frames are alternately arranged at an equal interval, the light emitting element side frames, on one hand, and the light receiving element side frames, on the other hand, having different shapes to each other;
forming light emitting element units by mounting light emitting elements on the light emitting element side frames, connecting to each other and molding the light emitting elements, and forming light receiving element units by mounting light receiving elements on the light receiving element side frames, connecting to each other and molding the light receiving elements;
separating the hoop shaped frame into a light emitting element side hoop shaped frame and a light receiving element side hoop shaped frame;
disposing the light emitting element units of the light emitting element side hoop shaped frame and the light receiving element units of the light receiving element side hoop shaped frame to arrange the light emitting elements, on one hand, and the light emitting elements, on the other hand, with a predetermined gap therebetween, and molding the light emitting element units of the light emitting element side hoop shaped frame and the light emitting element units of the light receiving element side hoop shaped frame in one body; and
separating the light emitting element side and light receiving element side hoop shaped frames into pieces each including one light emitting element unit and one light receiving element unit.

According to a further aspect of the present invention, there is provided a photo-coupling apparatus comprising:
a light emitting element;
a first lead frame having a reflector portion, the light being emitting element mounted on and connected to the reflector portion of the first lead frame;
a light receiving element;
a second lead frame having a different shape from the first lead frame, the light receiving element being mounted on and connected to the second lead frame;
a coupler which optically connect the light emitting element with the light receiving element; and
a molding which seals the light emitting element and the light receiving element.

According to a further aspect of the present invention, there is provided a method of manufacturing a photo-coupling apparatus, comprising:
forming a hoop shaped frame in which light emitting element side frames and light receiving element side frames are alternately arranged at an equal interval, the light emitting element side frames, on one hand, and the light receiving element side frames, on the other hand, having different shapes to each other;
forming light emitting element units by mounting light emitting elements on the light emitting element side frames and connecting to each other;
separating the hoop shaped frame into a light emitting element side hoop shaped frame and a light receiving element side hoop shaped frame;
optically connecting the light emitting elements of the light emitting element side hoop shaped frame with the light receiving elements of the light receiving element side hoop shaped frame;
molding the light emitting elements of the light emitting element side hoop shaped frame and the light emitting elements of the light receiving element side hoop shaped frame in one body; and
separating the light emitting element side and light receiving element side hoop shaped frames into pieces each including one light emitting element and one light receiving element.

### BRIEF DESCRIPTION OF THE SEVERAL VIEWS OF THE DRAWING

FIG. 1 is a perspective view illustrating a photo-interrupter according to a first embodiment of the present invention.

FIG. 2 is a cross sectional view illustrating the photo-interrupter of FIG. 1 taken along line II-II in the first embodiment of the invention.

FIG. 3 is a chart showing a process flow of manufacturing the photo-interrupter in the first embodiment of the invention.

FIG. 4 is a cross sectional view at one process of manufacturing the photo-interrupter in the first embodiment of the invention.

FIG. 5 is a cross sectional view illustrating a light emitting side lead frame of the photo-interrupter in the first embodiment of the invention.

FIG. 6 is a cross sectional view in one process of manufacturing the photo-interrupter in the first embodiment of the invention.

FIG. 7 is a perspective view illustrating a light emitting element unit of the photo-interrupter in the first embodiment of the invention.

FIG. 8 is a cross sectional view at one process of manufacturing the photo-interrupter in the first embodiment of the invention.

FIG. 9 is a side view illustrating a photo-interrupter according to a second embodiment of the present invention.

FIG. 10 is a front view illustrating a photo-interrupter according to a third embodiment of the present invention.

FIG. 11 is a top view illustrating the photo-interrupter of FIG. 10 in the third embodiment of the present invention.

FIG. 12 is a front view illustrating a photo-interrupter according to a fourth embodiment of the present invention.

FIG. 13 is a front view illustrating a modified example of the photo-interrupter in the fourth embodiment of the present invention.

FIG. 14 is a cross sectional view illustrating a photo-interrupter according to a fifth embodiment of the present invention.

FIG. 15 is a cross sectional view illustrating a photo-interrupter according to a sixth embodiment of the present invention.

FIG. 16 is a cross sectional view illustrating an optical coupling apparatus according to a seventh embodiment of the present invention.

FIG. 17 is a perspective view illustrating a conventional photo-interrupter.

FIG. 18 is a chart showing a process flow of manufacturing the conventional photo-interrupter.

FIG. 19 is a perspective view illustrating a light emitting element unit of the conventional photo-interrupter.

### DETAILED DESCRIPTION OF THE INVENTION

Hereinafter, embodiments of the present invention will be described with reference to the accompanying drawings.

(First Embodiment)

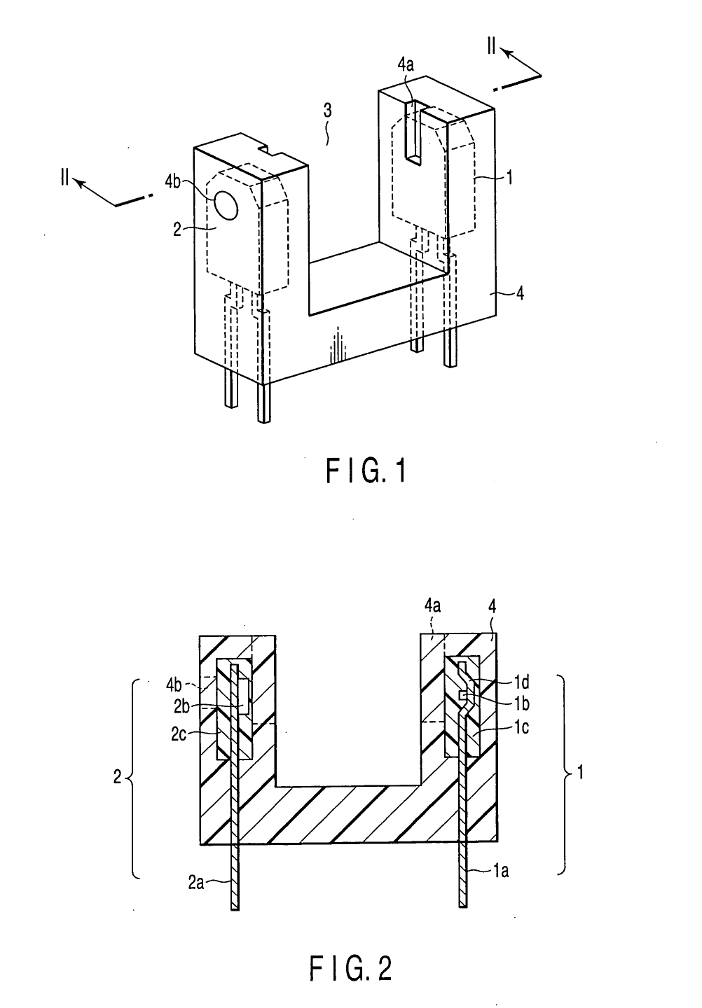

A perspective view and a cross sectional view of a photo-interrupter according to a first embodiment of the present invention are shown in FIG. 1 and FIG. 2, respectively.

As shown in FIG. 1, in the photo-interrupter, an envelope 4 is a molded envelope made of a thermoplastic resin. The envelope 4 is provided in a form of a simultaneous molding with a light emitting element unit 1 and a light receiving element unit 2 by using a cavity-mold. The light emitting element unit 1 and the light receiving element unit 2 face each other across a predetermined gap 3.

As shown in FIG. 2, the light emitting element unit 1 is composed of a light emitting side lead frame 1a, a light emitting element 1b placed on and connected to the lead frame 1a, and a resin portion 1c molding the light emitting side lead frame 1a and the light emitting element 1b. The light receiving element unit 2 is composed of a light receiving side lead frame 2a, a light receiving element 2b placed on and connected to the lead frame 2a, and a resin portion 2c molding the light receiving side lead frame 2a and the light receiving element 2b. The light emitting side lead frame 1a and the light receiving side lead frame 2a have shapes different from each other. A concave portion forming a reflector 1d is provided on the light emitting side lead frame 1a, and the light emitting element 1b is provided on the reflector 1d.

As shown in FIG. 1 and FIG. 2, a rectangular optical waveguide hole (slit) 4a for guiding a light from the light emitting element to the light receiving element is provided at the envelope 4 in a direction perpendicular to an optical waveguide direction. Also, an ejector pin hole 4b provided by drawing out an ejector pin from the envelope after the envelope is formed by molding using a cavity-mold is provided at the envelope 4.

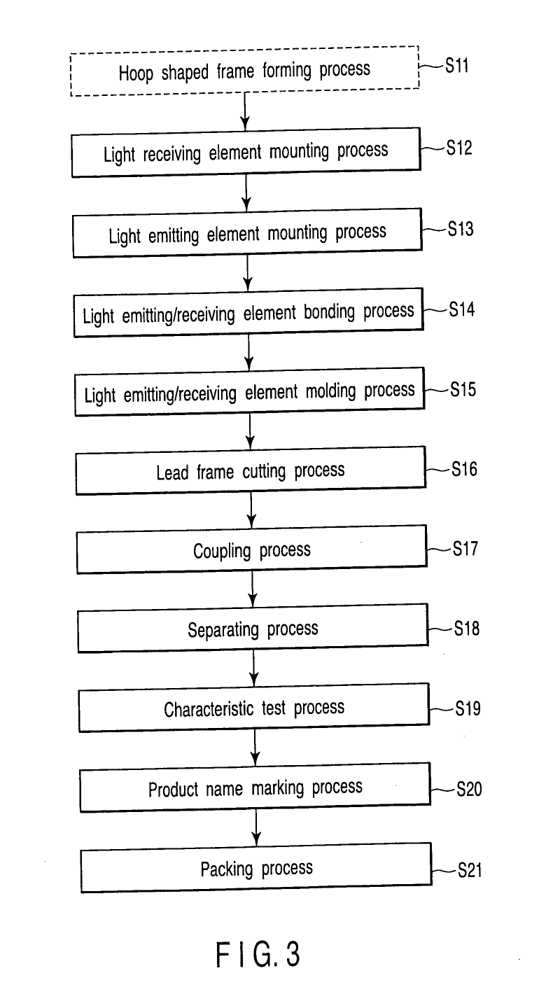

Such a photo-interrupter is provided in accordance with a process flow including processes S11 to S21 as shown in FIG. 3.

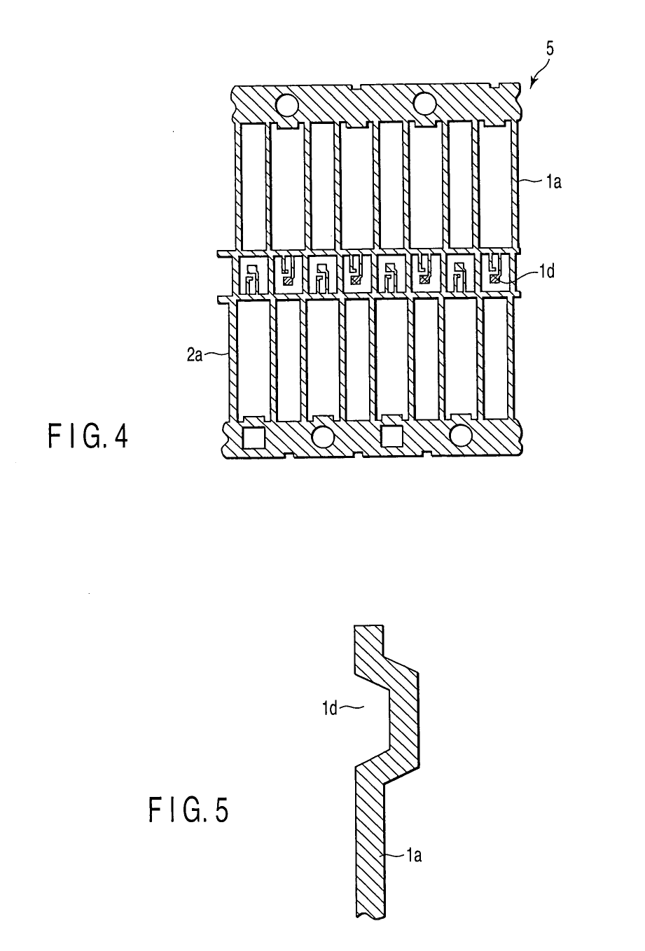

First, in a hoop shaped frame forming process S11, as shown in FIG. 4, a hoop shaped frame 5 in which a plurality of the light emitting side lead frames 1a and a plurality of light receiving side lead frames 2a are alternately arranged is formed. A concave portion forming the reflector 1d, as shown in a cross sectional view of FIG. 5, is provided at each of the light emitting side lead frames 1a.

Next, on the hoop line, the light receiving element 2b (FIG. 2) is mounted on the light receiving side lead frame 2a in a light receiving element mounting process S12. Further, the light emitting element 1b (FIG. 2) is mounted on the light emitting side lead frame 1a in a light emitting element mounting process S13.

Next, in a light emitting/receiving element bonding process S14, the light emitting element 1b and the light receiving element 2b are connected to the light emitting side lead frame 1a and the light receiving side lead frame 2a, respectively, by bonding wires (not shown).

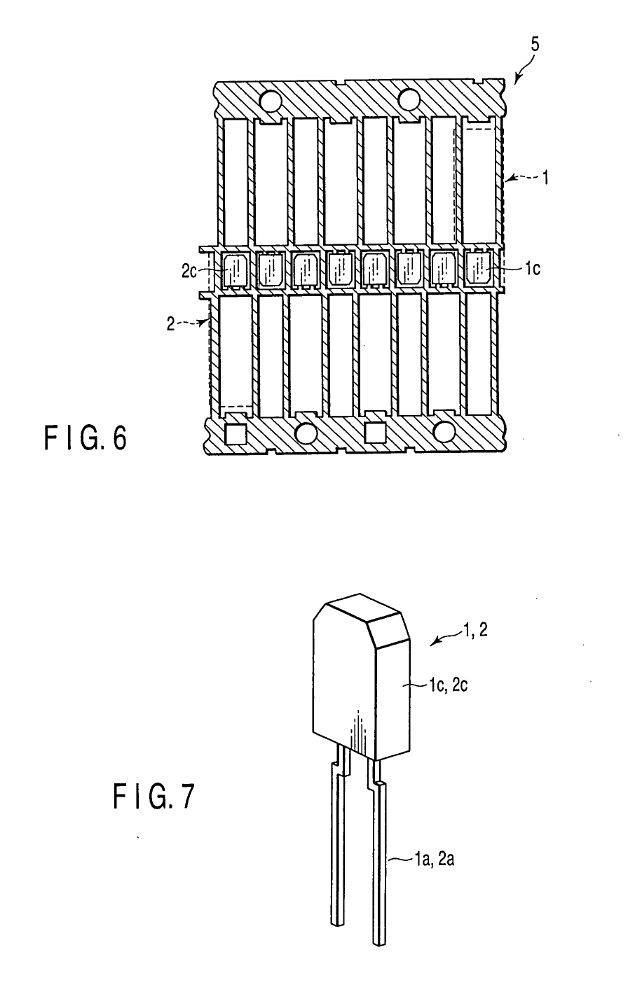

Moreover, in a light emitting element mold process S15, as shown in FIG. 6, the light emitting element 1b and the light emitting side lead frame 1a are molded and also the light receiving element 2b and the light receiving side lead frame 2a are molded so that the light emitting element unit 1 and the light receiving element unit 2 are provided.

A perspective view of one light emitting element unit 1 is shown in FIG. 7. Since a perspective view of the light receiving element unit 2 is the same as that of the light emitting element unit 1, reference numerals 2, 2a, and 2c relating to the light receiving element unit are shown in FIG. 7 in addition to reference numerals 1, 1a, and 1c relating to the light emitting element unit. A lens conventionally provided at the light emitting plane side of the light emitting element unit 1 (in the light receiving element unit 2, the light receiving plane side thereof) is not provided. Therefore, the thickness of the light emitting element unit 1 is just a thickness of the molding 1c, and is, for example, 0.55 mm thickness. In the same way, a lens conventionally provided is not provided at the light receiving plane side of the light receiving element unit 2. Therefore, the thickness of the light receiving element unit 2 is just a thickness of the molding 2c, and is, for example, 0.55 mm thickness.

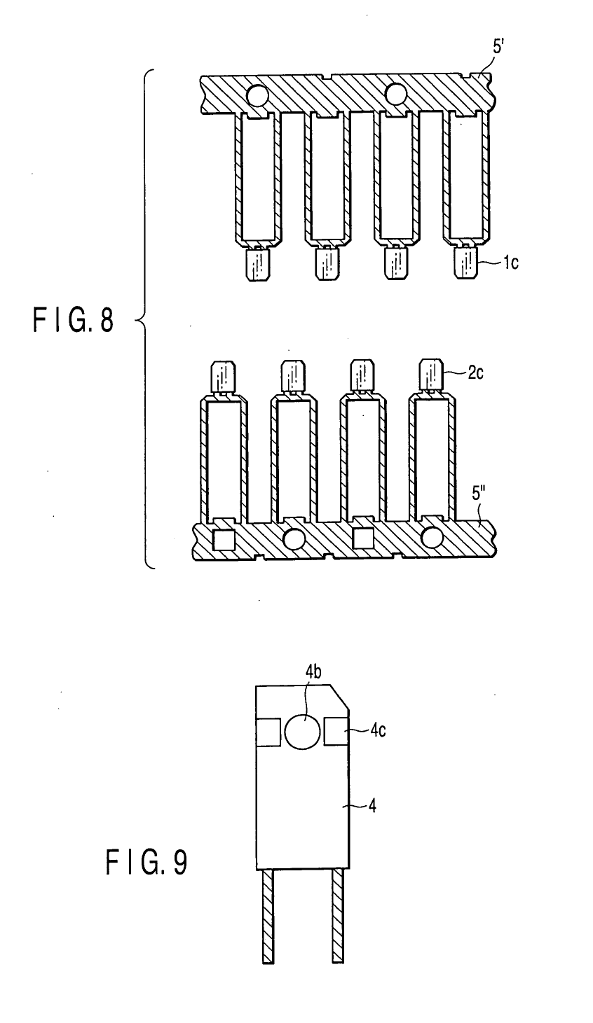

In a lead cutting process S16, the hoop shaped frame 5 in which the light emitting element units 1 and the light receiving element units 2 are alternately arranged is separated into a light emitting side hoop shaped frame 5′ and a light receiving side hoop shaped frame 5″, as shown in FIG. 8.

In a coupling process S17, the light emitting side hoop shaped frame 5′ and the light receiving side hoop shaped frame 5″ are inserted into a cavity-mold, while being arranged in the optical axis direction (i.e., the optical wave-guide direction) by an ejector pin being passed through an ejector pin through-hole 4b to have a predetermined interval (for example, 5 mm) therebetween (FIG. 1 and FIG. 2). A thermoplastic resin is injected into the cavity-mold to form an envelope in integral with the light emitting side hoop shaped frame 5′ and the light receiving side hoop shaped frame 5″ to provide a coupled frame of photo-interrupters.

The coupled frame is then separated into individual photo-interrupters in a separating process 18, so that a plurality of photo-interrupters are provided, as shown in FIG. 1. The formed photo-interrupter is shipped via a characteristic inspection process S19, a product name marking process S20, and a packing process S21. The separating process S18 and the characteristic inspection process S19 may be carried out in reverse order.

In the photo-interrupter formed in this way, a lens occupying ⅓ to ¼ of the element unit thickness is not provided. Instead, the reflector 1d is provided at the light emitting element unit 1. An emitted light is conducted to the light receiving element unit at high efficiency by the reflector 1d. The thickness of the reflector 1d is small, and thus the photo-interrupter is down-sized. Further, since the volume of resin can be reduced, the stress of resin can be suppressed, and the reliability of the photo-interrupter can be improved.

On the other hand, in the manufacturing process, since the hoop shaped frame in which the light emitting side frames and the light receiving side frames are integrated is used, the light emitting side frame and the light receiving side frame whose shapes are different from one another can be formed by one cavity-mold. Namely, the light emitting side frame and the light receiving side frame having different shapes which are desired shapes from optical, thermal, and mechanical standpoints can be formed at the same process. Moreover, an expensive mold for forming a lens portion is unnecessary. A mirror finish for the lens is unnecessary as well. Therefore, the molding time can be shortened. Further, since reversing the frame upside down for suppressing residual bubbles in the lens portion is unnecessary, coupling of the light emitting element unit and the light receiving element unit is possible while maintaining the production method by the hoop line. Therefore, high productivity can be achieved at a low cost.

(Second Embodiment)

A side view of a photo-interrupter according to a second embodiment of the present invention is shown in FIG. 9.

As shown in FIG. 9, an ejector pin hole 4b is formed at the center portion of the side of the envelope 4. Also, guide pin recesses 4c are formed at the left and right edges of the ejector pin hole on the side of the envelope 4. The ejector pin hole 4b is provided by drawing out an ejector pin from the envelope after the envelope is formed by resin molding using a cavity-mold, in which molding the light emitting side hoop shaped frame are coupled with the light receiving side hoop shaped frame, while being arranged in the optical axis direction by the ejector pin and the guide pins in the coupling process. As in the ejector pin hole, the guide pin recesses 4c are provided by drawing out guide pins from the envelope after the envelope is formed by resin molding using the cavity-mold, in which molding the light emitting side hoop shaped frame are coupled with the light receiving side hoop shaped frame, while being arranged in the optical axis direction by the ejector pin and the guide pins in the coupling process. Other configurations are the same as in the first embodiment, and descriptions thereof are omitted.

In the present embodiment, guide pins are used when the envelope is formed by resin molding using a cavity-mold, to easily and properly dispose the light emitting side hoop shaped frame and the light receiving side hoop shaped frame in the cavity-mold. The guide pins correspond in shape to the light emitting element unit and the light receiving element unit, so that these units are properly set in a predetermined position.

In this way, a deviation of the light emitting element unit and the light receiving element unit in the optical axis direction thereof is suppressed by the ejector pin, and also a deviation of the light emitting element unit and the light receiving element unit in the left and right sides or in the upper and lower sides thereof can be suppressed by the guide pins. That is, the light emitting element units and the light emitting element units are arranged by the ejector pin in a direction of the gap between the light emitting element unit and the light receiving element unit and/or in a normal direction of the gap.

Moreover, the recesses 4c can be used as a reference when the photo-interrupter is mounted on a substrate. Moreover, when the plane in which the recesses 4c are formed is adhered to a substrate, the adhesive strength can be improved since the surface area of the plane is increased with the recesses 4c being provided thereon.

(Third Embodiment)

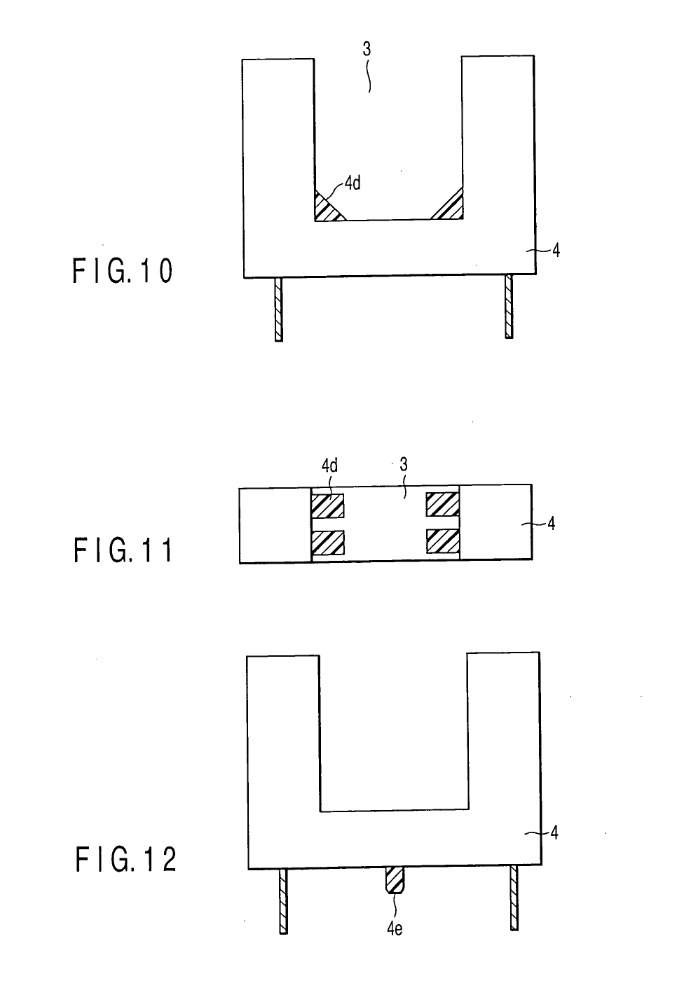

A front view and a top view of a photo-interrupter according to a third embodiment of the present invention are shown in FIG. 10 and FIG. 11, respectively.

As shown in FIG. 10 and FIG. 11, tapers 4d are formed at the corners inside the gap 3 of the envelope 4, i.e., the inner corners of the bottom portion and the light emitting side portion of the envelope 4 and the inner corners of the bottom portion and the light receiving side portion of the envelope 4. Other configurations are the same as in the first embodiment, and descriptions thereof are omitted.

The tapers 4d are provided simultaneously with the time when the envelope 4 is molded by using a cavity-mold.

By providing the tapers 4d, it can be suppressed that the envelope to be formed is transformed toward the inside or the outside of the gap due to resin shrinkage by residual strain at the time of forming the envelope using resin. That is, the tapers function as stress absorbers. Further, at the time of handling in the manufacturing process, it is possible to prevent the defect, such that the envelope is broken when a force in the gap direction is applied thereto, which newly arises due to the miniaturization of the photo-interrupter.

(Fourth Embodiment)

A side view of a photo-interrupter according to a fourth embodiment of the present invention is shown in FIG. 12.

As shown in FIG. 12, a boss 4e is provided at the bottom surface (mounting surface) of the envelope 4. Other configurations are the same as in the first embodiment, and descriptions thereof are omitted.

The boss 4e is provided simultaneously with the time when the envelope 4 is formed by resin-mold by using a cavity-mold.

Since the boss 4e is provided in this embodiment, the photo-interrupter can be precisely and easily positioned on the substrate such as a paper phenolic substrate, a glass epoxy substrate, or the like, when the photo-interrupter is mounted on the substrate. In accordance therewith, it is possible to prevent the defect such that a lead pin cannot be inserted into a predetermined position of the substrate, and the lead is folded at the time of being inserted.

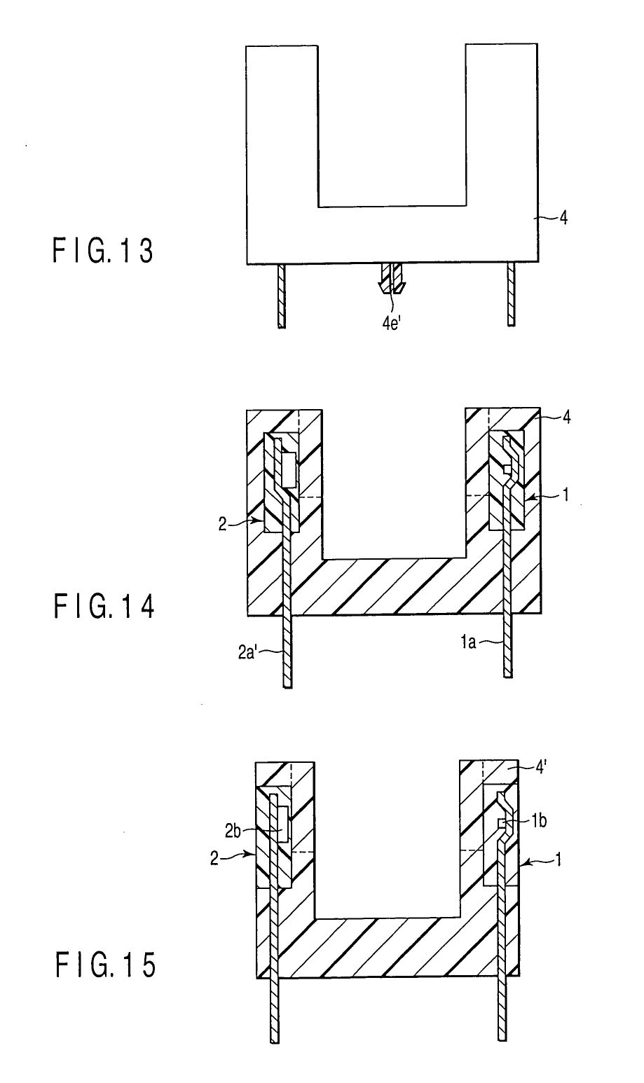

The boss is not limited to such a boss composed of only a columnar portion as shown in FIG. 12. For example, as shown in FIG. 13, the boss may be a so-called a snap-on configuration 4e′ in which a snap-on protruding portion extending in the radial direction is provided at the top end of the columnar portion. Since the boss is provided in this embodiment, the photo-interrupter can be firmly attached to the substrate when the photo-interrupter is mounted on the substrate. Therefore, it is possible to prevent the deficiency, such that the photo-interrupter is made to float at the time of flow-soldering since the weight of the photo-interrupter is too light, which newly arises due to the miniaturization of the photo-interrupter.

(Fifth Embodiment)

A cross sectional view of a photo-interrupter according to a fifth embodiment of the present invention is shown in FIG. 14. As shown in FIG. 14, a lead frame 2a′ at which a depressed portion is provided is used at the light receiving portion side. The light receiving element is mounted on the depressed portion. Other configurations are the same as in the first embodiment, and descriptions thereof are omitted.

The depressed portion is provided simultaneously when the hoop shaped frame is formed or when the concave portion forming the reflector is provided at the light emitting side lead frame.

In this way, with the depressed portion being provided at the lead frame, it is possible to improve mechanical strength such as a tensile strength of the lead frame. Accordingly, the light receiving element mounted on the depressed portion is prevented from a mechanical stress.

(Sixth Embodiment)

A cross sectional view of a photo-interrupter according to a sixth embodiment of the present invention is shown in FIG. 15.

As shown in FIG. 15, resin is not provided at the backside portion (i.e., the non-light emitting side portion) of the light emitting element unit of the envelope 4′. In other words, a recess is provided at the backside portion of the light emitting element unit, and thus the backside portion of the light emitting element unit is exposed. Similarly, resin is not provided at the backside portion (i.e., the non-light receiving side portion) of the light receiving element unit of the envelope 4′. In other words, a recess is provided at the backside portion of the light receiving element unit, and thus the backside portion of the light receiving element unit is exposed. Other configurations are the same as in the first embodiment, and descriptions thereof are omitted.

Such a configuration can be obtained by molding using a cavity-mold, as an envelope forming cavity, of a form with which resin is not provided at the backside portion of the light emitting element Unit and also resin is not provided at the backside portion of the light receiving element unit.

When the resin thickness of the backside portion of the light emitting element unit and the resin thickness of the backside portion of the light receiving element unit are, for example, 250 μm, the total thickness of both the backside portions is made to be 500 μm. Since, in this embodiment, resin is not provided at the backside portion of the light emitting element unit and also resin is not provided at the backside portion of the light receiving element unit, the resin thickness of the total thickness of 500 μm is reduced, and it is possible to miniaturize the envelope in the length direction.

(Seventh Embodiment)

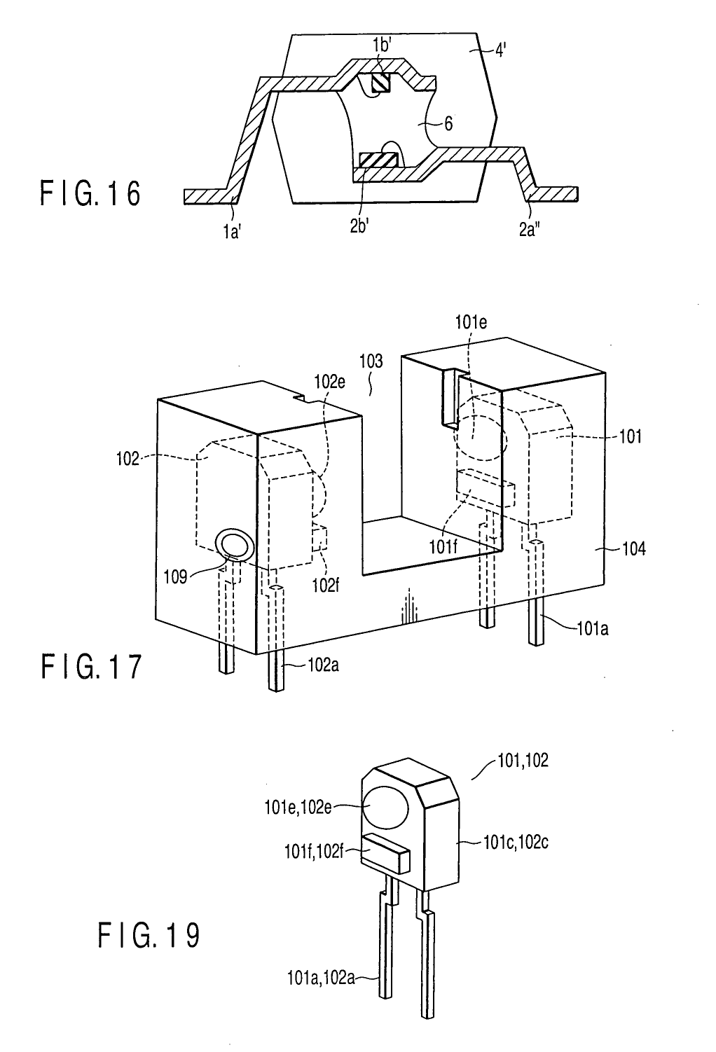

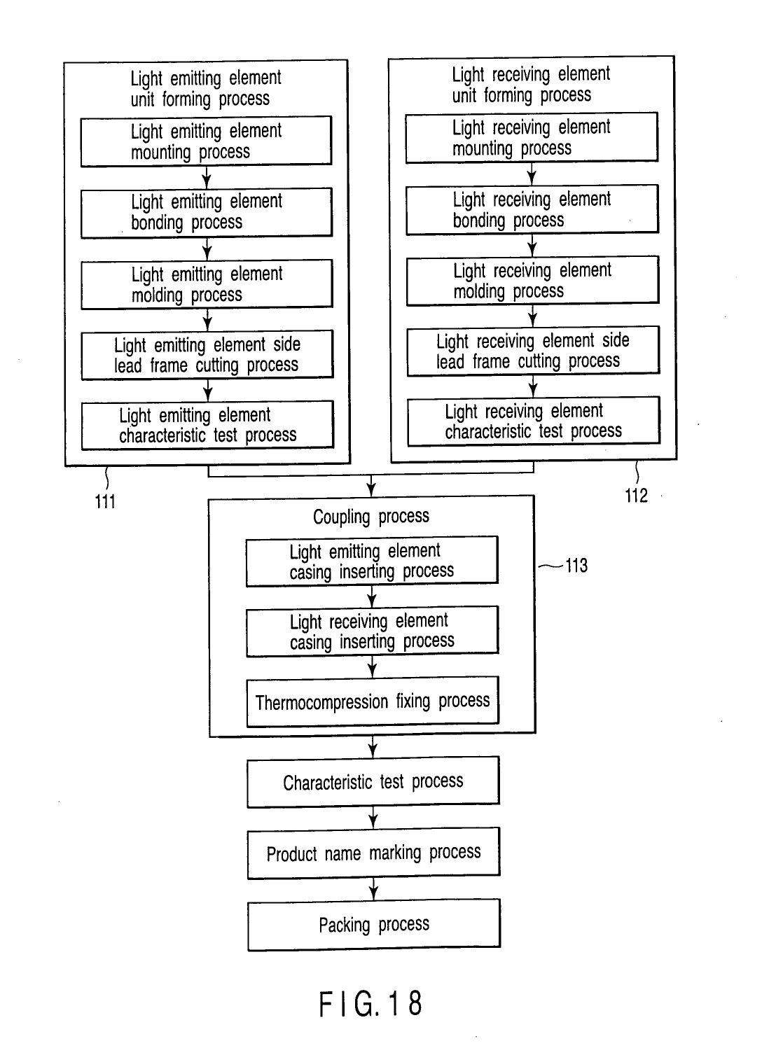

The formation of the optical coupling apparatus in accordance with the hoop line is not limited to the photo-interrupters as disclosed in the foregoing embodiments, and may be applied to the formation of an optical coupling apparatus as shown in FIG. 16.

With respect to the formation of the photo coupling apparatus as shown in FIG. 16, light emitting elements 1b′ and light receiving elements 2b′ are mounted on and connected to a hoop shaped frame formed from a light emitting side lead frame 1a′ and a light receiving side lead frame 2a″. In other words, the light emitting elements 1b′ are mounted on and connected to light emitting side lead frames 1a′, and light receiving elements 2b′ are mounted on and connected to light receiving side lead frames 2a″. The light emitting side lead frame 1a′, on one hand, and the light receiving side lead frame 2a″, on the other hand, have shapes different from each other.

Next, the hoop shaped frame is cut and separated into a light emitting side hoop shaped frame and a light receiving side hoop shaped frame. Thereafter, optical coupling of the light emitting elements and the light receiving elements is carried out by using light transmittable resin 6 while maintaining the hoop line, and next, the light emitting element portions and the light receiving element portions are molded by light shielding resin 4″, and then the molding is separated into individual photo couplers.

In the manufacturing process, since the hoop shaped frame in which the light emitting side frames and the light receiving side frames are integrated is used, the light emitting side frame and the light receiving side frame whose shapes are different from each other can be formed by using one cavity-mold. Namely, the light emitting side frame and the light receiving side frame having different shapes which are desired shapes from optical, thermal, and mechanical standpoints can be formed at the same process. Moreover coupling of the light emitting element unit and the light receiving element unit is possible while maintaining the production method by the hoop line. Therefore, high productivity can be achieved at a low cost. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A photo-interrupter comprising:
a molded light emitting element unit including a first lead frame and a light emitting element mounted on and connected to the first lead frame, the first lead frame having a reflector portion;
a molded light receiving element unit including a second lead frame and a light receiving element mounted on and connected to the second lead frame, the second lead frame having a different shape from the first lead frame; and
an envelope molding formed in one piece with the light emitting element unit and the light receiving element unit, in which the light emitting element unit and the light receiving element unit are arranged with a predetermined gap therebetween, the envelope molding having a light guiding hole for guiding a light beam emitted from the light emitting element unit to the light receiving element.

2. A photo-interrupter according to claim 1, wherein the envelope has a recess in a backside portion of the light emitting element unit and a recess in a backside portion of the light receiving element unit.

3. A photo-interrupter according to claim 1, wherein a stress absorber is provided between the light emitting element unit and the light receiving element unit.

4. A photo-interrupter according to claim 1, wherein a boss is provided at a mounting plane of the envelope.

5. A photo-interrupter according to claim 1, wherein the second lead frame has a depressed portion.

6. A photo-interrupter according to claim 1, wherein the backside portion of the light emitting element unit is exposed and the backside portion of the light receiving element unit is exposed.

7. A photo-interrupter according to claim 1, wherein a snap-on type boss is provided at a mounting plane of the envelope.

8. A photo-interrupter according to claim 1, wherein the envelope is provided with an ejector pin hole formed by drawing out an ejector pin from the envelope after the envelope is formed.

9. A photo-interrupter according to claim 8, wherein the envelope is further provided with guide pin recesses at opposite sides of the ejector pin hole, formed by drawing out the guide pins from the envelope after the envelope is formed.

10. A method of manufacturing a photo-interrupter, comprising:
forming a hoop shaped frame in which light emitting element side frames and light receiving element side frames are alternately arranged at an equal interval, the light emitting element side frames, on one hand, and the light receiving element side frames, on the other hand, having different shapes to each other;
forming light emitting element units by mounting light emitting elements on the light emitting element side frames, connecting to each other and molding the light emitting elements, and forming light receiving element units by mounting light receiving elements on the light receiving element side frames, connecting to each other and molding the light receiving elements;
separating the hoop shaped frame into a light emitting element side hoop shaped frame and a light receiving element side hoop shaped frame;
disposing the light emitting element units of the light emitting element side hoop shaped frame and the light receiving element units of the light receiving element side hoop shaped frame to arrange the light emitting elements, on one hand, and the light emitting elements, on the other hand, with a predetermined gap therebetween, and molding the light emitting element units of the light emitting element side hoop shaped frame and the light emitting element units of the light receiving element side hoop shaped frame in one body; and
separating the light emitting element side and light receiving element side hoop shaped frames into pieces each including one light emitting element unit and one light receiving element unit.

11. A method of manufacturing a photo-interrupter, according to claim 10, wherein in molding the light emitting element units and the light emitting element units, the light emitting element units and the light emitting element units are arranged by an ejector pin in a direction of the gap and/or in a normal direction of the gap.

12. A method of manufacturing a photo-interrupter, according to claim 10, wherein in molding the light emitting element units and the light emitting element units, a stress absorber is provided between the light emitting element unit and the light receiving element unit, simultaneously.

13. A method of manufacturing a photo-interrupter, according to claim 10, wherein in molding the light emitting element units and the light emitting element units, a boss is provided simultaneously.

14. A photo-coupling apparatus comprising:
a light emitting element;
a first lead frame having a reflector portion, the light being emitting element mounted on and connected to the reflector portion of the first lead frame;
a light receiving element;
a second lead frame having a different shape from the first lead frame, the light receiving element being mounted on and connected to the second lead frame;
a coupler which optically connect the light emitting element with the light receiving element; and
a molding which seals the light emitting element and the light receiving element.

15. A method of manufacturing a photo-interrupter, comprising:
forming a hoop shaped frame in which light emitting element side frames and light receiving element side frames are alternately arranged at an equal interval, the light emitting element side frames, on one hand, and the light receiving element side frames, on the other hand, having different shapes to each other;
forming light emitting element units by mounting light emitting elements on the light emitting element side frames and connecting to each other;
separating the hoop shaped frame into a light emitting element side hoop shaped frame and a light receiving element side hoop shaped frame;
optically connecting the light emitting elements of the light emitting element side hoop shaped frame with the light receiving elements of the light receiving element side hoop shaped frame;
molding the light emitting elements of the light emitting element side hoop shaped frame and the light emitting elements of the light receiving element side hoop shaped frame in one body; and
separating the light emitting element side and light receiving element side hoop shaped frames into pieces each including one light emitting element and one light receiving element.

16. A photo-interrupter according to claim 1, wherein the reflector portion comprises a concave portion of the first lead frame.
